(19) United States
(12) Patent Application Publication
(10) Pub. No.: US 2013/0338938 A1
(43) Pub. Date: Dec. 19, 2013

(54) Identifying wind or water turbines for maintenance

(71) Applicant: ROMAX TECHNOLOGY LIMITED, Nottingham (GB)

(72) Inventor: John Karl Coultate, Nottingham (GB)

(73) Assignee: ROMAX TECHNOLOGY LIMITED, Nottingham (GB)

(21) Appl. No.: 13/646,845

(22) Filed: Oct. 8, 2012

(30) Foreign Application Priority Data
Jun. 14, 2012 (GB) 1210582.1

(51) Int. Cl. G01M 15/00; G06F 19/00

(52) U.S. Cl. 702/35

(57) ABSTRACT

A method for identifying a wind or water turbine, or component thereof, for maintenance, comprises the steps of: determining an operating parameter value for the wind or water turbine; analyzing vibration data for the wind or water turbine; and comparing the vibration data with a threshold related to the operating parameter value. This approach means that vibration thresholds vary according to the expired life of wind or water turbine, leading to a more accurate identification of wind or water turbines which may be in need of maintenance, and which should be investigated.

### CROSS-REFERENCE TO RELATED APPLICATIONS

This application claims the benefit of U.K. Patent Application No. GB 1210582.1, filed Jun. 14, 2012.

### BACKGROUND OF THE INVENTION

The present invention relates to approaches for identifying a wind or water turbine or component thereof for maintenance.

Vibration is commonly-measured by Condition Monitoring Systems. Generally speaking, large vibrations compared to a norm is indicative of damage.

Vibration analysis generally relies on a measurement provided by a sensor exceeding a predetermined threshold, which is prone to false alarms if the threshold is set too low. The threshold level is not necessarily constant and may vary with frequency (and hence speed). The presence of shocks and extraneous vibrations means that the threshold level must be set sufficiently high to minimize the risk of false-alarms. Furthermore, the threshold must be sufficiently high to avoid any negative effects caused by ‘creep’ in sensor performance which may occur over its lifetime. In addition, there is no discrimination between vibrations associated with failure or damage and those which are not indicative of failure or damage.

Faults developing during operation, such as an imbalance in the rotor, can create loads on a bearing in excess of that expected resulting in a reduction in its design life. Incipient faults, such as unbalance, can be detected from analysis of vibration signatures. This gives the magnitude of an imbalance, and an excitation force due to imbalance is a function of the magnitude of the imbalance and square of the speed. An excitation force due to faults can thus be calculated from field operational conditions and used to calculate individual component loads. Deviation from the assumed operating profile can be addressed by using a generic wind simulation model to determine load at the turbine shaft, which allows individual component load based on the field operational conditions to be calculated. Combining these gives the total load at each component, which can be is used to estimate the remaining life of the individual components and the life of the gearbox.

However, shortcomings in wind simulation models mean that the load at the turbine shaft may not be reliably or accurately determined.

### BRIEF SUMMARY OF THE INVENTION

According to the present invention, there is provided a method for identifying a wind or water turbine, or component thereof, for maintenance, the method comprising the steps of: determining an operating life parameter for the wind or water turbine or component thereof; analyzing operating data for the wind or water turbine or component thereof; and comparing the operating data with a threshold related to the operating life parameter value. This approach means that operating thresholds vary according to the expired life of wind or water turbine, leading to a more accurate identification of wind or water turbines or components thereof which may be in need of maintenance, and which should be investigated.

Preferably, the method additionally comprises the step of setting thresholds for operating data according to one or more ranges of operating life parameter values. The thresholds are dependent on the age of the turbine, which overcomes some of the disadvantages with current vibration analysis.

Preferably the operating life parameter is accumulated power produced or accumulated turbine revolutions. This data can be easily collected.

Preferably, the operating data is vibration data. This is a commonly used operating parameter in Condition Monitoring Systems.

Preferably the operating life parameter is selected from the group of number of starts; number of stops; number of emergency stops; duration spent in a predetermined range of power; duration spent in a predetermined range of temperature; duration spent in a predetermined range of speed; duration spent in a predetermined range of torque; duration spent in a predetermined range of one or more forces and/or one more moments acting on the wind or water turbine rotor shaft.

Preferably, identifying a wind or water turbine or component thereof for maintenance comprises identifying a wind or water turbine or component thereof in which the operating data is greater than the threshold.

The present invention is a method for operating a wind or water turbine or component thereof based on a quantitative measure of vibration in relation to operating life parameter for a wind or water turbine or component thereof.

### BRIEF DESCRIPTION OF THE SEVERAL VIEWS OF THE DRAWING

FIG. 1 shows a graph combining operating life models with vibration data for a number of turbines operating in a wind farm; and

FIG. 2 illustrates a schematic diagram of an apparatus according to various embodiments of the invention.

### DETAILED DESCRIPTION OF THE INVENTION

The method may be illustrated by a simple example, in which operating parameter levels are stratified into three levels: low, medium and high.

As mentioned above, the danger or damage from increased vibration is dependent to a certain extent to the age of the wind or water turbine or component thereof. The age of the wind or water turbine, or component thereof, is related to measurable operating life parameters, such as the total power produced by the turbine to date, or the number of revolutions the turbine has made to date. Operating life parameters, such as accumulated power produced or accumulated turbine revolutions can be similarly stratified into three zones, low, medium and high.

Other operating life parameters include the number of starts; a number of stops; a number of emergency stops; a component fatigue life, a duration spent in a predetermined range of power; a duration spent in a predetermined range of temperature; a duration spent in a predetermined range of speed; a duration spent in a predetermined range of torque; a total duration of turbine downtime, a total duration spent at a particular oil quality, a duration spent in a predetermined range of one or more forces and/or one more moments acting on the wind or water turbine rotor shaft.

This simple approach enables the wind or water turbine operator to prioritize maintenance activities based on operating life parameters and CMS data, as for example in Table 1.

TABLE 1
Action needed according to a value for an operating life
parameter and a level of an operating parameter

| Operating | Operating life parameter | | |
|---|---|---|---|
| parameter | Low | Medium | High |
| High | | | Turbine inspection |
| | | | recommended |
| Medium | Investigation | Continuous | |
| | needed | monitoring | |
| Low | | | |

The same approach may be adopted for other CMS data which may be used to monitor wind or water turbines by identifying wind or water turbines which exceed a threshold value.

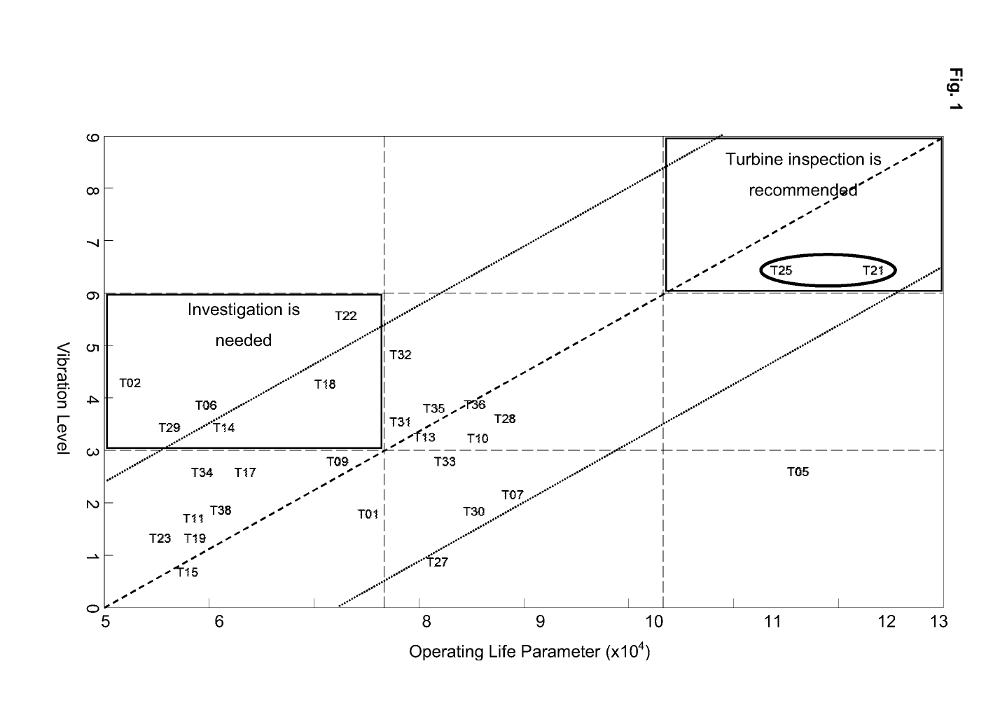

FIG. 1 shows a graph combining operating life models with vibration data for a number of turbines (T01 to T38) operating in a wind farm. Vibration levels in this context can be based on vibration signature analysis.

Turbines with moderate operating parameter values and vibration typically require continuous monitoring and planned inspections over a longer period.

Moderate levels of vibration when operating parameter values are low, for example turbine T02 in FIG. 1, may indicate that the wind or water turbine or component thereof should be investigated to see if one or more components are suffering damage and need to be repaired or replaced.

However, moderate levels of vibration at median values of operating parameter values are probably normal, and should be merely monitored continuously. Moderate levels of vibration at high values of operating parameter values require no action.

High levels of vibration at high operating parameter values may be indicative of a need for turbine inspection. Turbines with high operating parameter values and high vibration (circled) can clearly be identified, and these require inspection.

Turbine T34 in FIG. 1 has a similar vibration level to turbine T05, but turbine T02 has a low operating parameter value. The latter turbine is clearly operating better than other turbines of a similar operating parameter values. Using a system for identifying turbines in need of maintenance based on thresholds alone would consider these two turbines to have the same status.

In addition to the approaches above, an additional indicator of a requirement for maintenance may be obtained by collecting data relating to vibration of the wind or water turbine or component thereof on a test rig prior to installation. This can be taken as a subsequent baseline: increases in vibration after installation may be due to damage during transport or poor assembly.

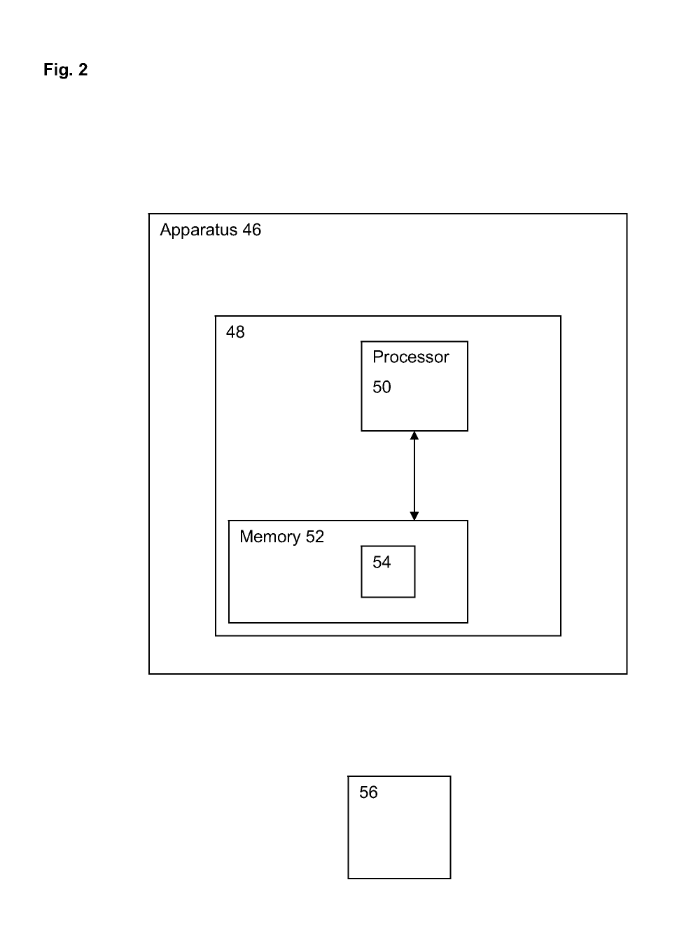

FIG. 2 illustrates a schematic diagram of an apparatus 46 according to various embodiments of the present invention. The apparatus 46 includes means 48 for performing the steps illustrated in FIG. 1 and Table 1. Means 48 includes a processor 50 and a memory 52. The processor 50 (e.g. a microprocessor) is configured to read from and write to the memory 52. The processor 50 may also comprise an output interface via which data and/or commands are output by the processor 50 and an input interface via which data and/or commands are input to the processor 50.

The memory 52 stores a computer program 54 comprising computer program instructions that control the operation of the apparatus 46 when loaded into the processor 50. The computer program instructions 54 provide the logic and routines that enables the apparatus 46 to perform at least some of steps of the methods illustrated in FIG. 1 and Table 1. The processor 50 by reading the memory 52 is able to load and execute the computer program 54. Although the memory 52 is illustrated as a single component it may be implemented as one or more separate components some or all of which may be integrated/removable and/or may provide permanent/semi-permanent/dynamic/cached storage.

The computer program may arrive at the apparatus 46 via any suitable delivery mechanism 56. The delivery mechanism 56 may be, for example, a computer-readable storage medium, a computer program product, a memory device, a record medium such as a Blu-ray disk, CD-ROM or DVD, an article of manufacture that tangibly embodies the computer program 54. The delivery mechanism may be a signal configured to reliably transfer the computer program 54. The apparatus 46 may propagate or transmit the computer program 54 as a computer data signal.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The steps illustrated in FIG. 1 and Table 1 may represent steps in a method and/or sections of code in the computer program 54. The illustration of a particular order to the steps does not necessarily imply that there is a required or preferred order for the steps and the order and arrangement of the steps may be varied. Furthermore, it may be possible for some steps to be omitted.

1. A method for identifying a wind or water turbine or component thereof for maintenance, said method comprising the steps of:
determining an operating life parameter for said wind or water turbine or component thereof;
analyzing operating data for said wind or water turbine or component thereof; and
comparing said operating data with a threshold related to said operating life parameter value.

2. The method of claim 1, additionally comprising the step of setting thresholds for operating data according to one or more ranges of operating life parameter values.

3. The method of claim 1 in which said operating data is vibration data.

4. The method of claim 1 in which said operating life parameter is selected from the group consisting of: accumulated power produced and accumulated turbine revolutions.

5. The method of claim 1 in which said operating life parameter is selected from the group consisting of: number of starts; number of stops; number of emergency stops; duration spent in a predetermined range of power; duration spent in a predetermined range of temperature; duration spent in a predetermined range of speed; duration spent in a predetermined range of torque; duration spent in a predetermined range of one or more forces and/or one more moments acting on said wind or water turbine rotor shaft.

6. The method of claim 1 in which identifying a wind or water turbine or component thereof for maintenance comprises identifying a wind or water turbine or component thereof in which said operating data is greater than said threshold.

7. A computer readable product comprising code means designed for implementing the steps of said method according to claim 1.

8. A computer system comprising means designed for implementing the steps of said method according to claim 1.
